(19) United States
(12) Patent Application Publication
(10) Pub. No.: US 2016/0044043 A1
(43) Pub. Date: Feb. 11, 2016

(54) METHOD AND DEVICE FOR TRANSMITTING A FILE CONTAINING A CONTROLLED-ACCESS MULTIMEDIA CONTENT

(71) Applicant: ORANGE, Paris (FR)

(72) Inventors: Bertrand Bouvet, Perros-Guirec (FR); Catherine Salou, Lannion (FR)

(21) Appl. No.: 14/773,723

(22) PCT Filed: Mar. 25, 2014
(86) PCT No.: PCT/FR2014/050700

§ 371 Date: Sep. 8, 2015

(30) Foreign Application Priority Data
Mar. 28, 2013 (FR) 1352800

(51) Int. Cl. H04L 29/06; G06F 21/10

(52) U.S. Cl. CPC H04L 63/105; G06F 21/10; G06F 2221/0737; G06F 2221/0704

(57) ABSTRACT

The invention relates to a method for transmitting a controlled-access multimedia content to at least one recipient terminal. The method comprises a step of inserting into a file containing the multimedia content at least one identifier relating to the recipient terminal or to the user of the recipient terminal, the identifier being intended to control access to the multimedia content by the recipient terminal, and a step of dispatching the file to at least the recipient terminal. The invention also relates to a corresponding transmission device.

The invention lies within the field of multimedia content protection.

The invention relates to the protection of audio, image and video content created by a user who is using a terminal, for example a device such as a smartphone (the English term for an intelligent telephone), camera or PC, or contents stored on his terminal.

When a user transmits content to a recipient, there is no way of controlling what the recipient will do with this content. The recipient may record, transfer or modify it as he wishes.

The content protection methods such as DRM (the abbreviation of the English expression “Digital Rights Management”) are used by content providers to protect, and give certain rights to, users in respect of works of art. These methods use a system based on a license which a user must acquire in order to access content. When the content is downloaded, the terminal must verify at a license server that the user has actually acquired the rights to the content.

The document WO2008/006821 proposes a method of controlled sharing of personal data between a first terminal of a first user and a second terminal of a second user. When the second user wishes to obtain personal data from the first user, the second terminal sends a request to a correspondence server in order to receive a reference relating to the first user.

This reference characterizes the user with which it is associated, and is anonymous so that no other user will know it.

The second terminal then sends a data sharing request to the first terminal. On receiving this, the first terminal stores a reference relating to the second user in association with the shared personal data, and sends the shared personal data to the second terminal with a reference relating to the first user.

On receiving the data, the second terminal records the shared personal data in association with the reference relating to the first user.

The first user can control the data that he has shared with the second user, by means of control commands which are transmitted to the second terminal and can be used to update or delete the shared data.

This method is complicated for the first user, because the control of the access to the personal data of the first user must take place whenever a user sends a sharing request to the first user.

This method requires the use of a correspondence server to manage the references to the users. Moreover, this method does not enable the first user to control the access of other users to the data shared with the second user.

The invention is intended, notably, to overcome the aforesaid drawbacks of the prior art.

### DISCLOSURE OF THE INVENTION

To this end, the invention proposes a method of transmitting a controlled-access multimedia content to at least one recipient terminal. The method comprises a step of inserting into a file containing the multimedia content at least one identifier relating to the recipient terminal or to the user of the recipient terminal, the identifier being intended to control access to the multimedia content by the recipient terminal, and a step of sending the file to at least the recipient terminal.

In association with this, the invention also relates to a device for transmitting a controlled-access multimedia content to at least one recipient terminal. The transmission device comprises means for inserting into a file containing the multimedia content at least one identifier relating to the recipient terminal or to the user of the recipient terminal, the identifier being intended to control the access to the multimedia content by the recipient terminal, and means for sending the file to at least the recipient terminal.

The transmission method and device according to the invention can be used to make the content which a user wishes to transmit to another user secure in a simple and automatic manner. As a result of the invention, only the recipient users whose identifiers have been inserted into the content will be able to access the content.

The transmission method and device according to the invention can be used to make a user's content secure, without requiring the presence of a server to control the authorization for access to the content by the recipient users.

When the identifiers of the recipients have been inserted into the file containing the multimedia content, the user who owns the content no longer needs to carry out any operations on the file to make access to the multimedia content secure. Notably, the user does not need to set the access rights to the content for a recipient user on each content sharing request.

The invention is applicable to any type of multimedia content, such as images, sound, text, video, or graphics.

The different forms or characteristics of embodiment mentioned below may be added, independently or in combination with one another, to the steps of the transmission method as defined above.

According to a particular embodiment of the invention, the insertion step is performed during the creation of the multimedia content by the content creation terminal. This embodiment simplifies the use of the method for the user who generates content with his terminal. The user does not have to perform any further operations on the file of the multimedia content in order to make the access to the content secure.

According to another particular embodiment of the invention, the insertion step is performed during a current call between a terminal sending the multimedia content and a recipient terminal. In this embodiment, when a user wishes to share content with another party, this method makes it possible to set access rights to the content for the other party in a simple manner, by using identifiers of the other party used for the current call. Optionally, these access rights may be set for a limited period or a single reading of the content.

According to another particular embodiment of the invention, the identifier relating to the recipient terminal or to the user of the recipient terminal is an identifier contained in an address book stored in the terminal sending the multimedia content, or in remote equipment.

The setting of the access rights to the content is automatic for the contacts of the user who owns the content that is to be made secure. The configuration of the access rights can thus be carried out for one or more contacts of the user on a single occasion.

According to another particular embodiment of the invention, the method further comprises a step of inserting into the file containing the multimedia content at least one identifier relating to the terminal that created the multimedia content or to the user of the terminal that created the multimedia content. The terminal of a user owning multimedia content to be made secure can thus verify whether a user wishing to modify the access rights to the content is authorized to do so. This embodiment also makes it possible to control the terminal which makes the modification of the access rights, depending on whether the user owning the content does or does not wish this modification to be made from a terminal other than the terminal that has been used to create the file.

According to another particular embodiment of the invention, the identifier relating to the recipient terminal or to the user of the recipient terminal and/or the identifier relating to the terminal that created the multimedia content or to the user of the creating terminal belongs to the group comprising:
a telephone number,
an address of a network interface card of a terminal,
an electronic mail address,
an international identification number of a mobile terminal,
a serial number of a terminal,
an address of a website (URL, for “Uniform Resource Locator” in English),
an SIP URI (for Session Initiation Protocol Uniform Resource Identifier in English) address,
an IP (for Internet Protocol in English) address,
a domain name.

The identifier can thus relate to a personal device of the user, or to an account of the user (messaging, social network, client, etc.).

The recipient may also be a website (photo/video sharing site, social network).

The recipient terminal of the multimedia content which controls the rights of access to the content can thus verify the access rights on the basis of identifiers which he can easily access, for example an identifier of the user or of the terminal stored in an internal memory of the terminal or on the SIM (for Subscriber Identity Module in English) card of the terminal.

According to another particular embodiment of the invention, the transmission method further comprises:
a step of determining at least one rule for using the multimedia content associated with the recipient terminal or with the user of the recipient terminal, and
a step of inserting a data element representative of the at least one determined rule of use into the file.

The recipient can thus have rights of management of the content, in respect of reading, modification, deletion, local or external recording, sharing, or transfer.

The user owning the content to be made secure controls the access and the use made of the multimedia content on the basis of the recipient.

According to another particular embodiment of the invention, the determination of the at least one rule of use is carried out on the basis of a history of calls exchanged between the terminal sending the multimedia content and the recipient terminal.

Thus the rule of use is determined automatically. It may differ according to the frequency and number of calls that have been exchanged between the sending terminal and the recipient terminal, or the time elapsed since the last exchange.

According to another particular embodiment of the invention, the transmission method comprises, before the step of inserting an identifier relating to the recipient terminal or to the user of the recipient terminal into the file:
a step of verifying the presence of an identifier relating to the terminal sending the multimedia content or to the user of the terminal sending the multimedia content,
and a step of verifying the rules of use of the multimedia content associated with the identifier relating to the terminal sending the multimedia content or to the user of the terminal sending the multimedia content.

If the sending terminal wishes to modify the file containing the controlled-access multimedia content, notably in order to add a new recipient for example, the transmission method verifies that the sending terminal is authorized to do this.

This particular embodiment of the invention makes it possible to limit the number of terminals that can modify the access rights to the file. Only the terminals or users having a modification right indicated in the file will be able to modify it.

According to another particular embodiment of the invention, the transmission method comprises, before the step of sending the file, a step of verifying the presence in the file of an identifier relating to the recipient terminal or to the user of the recipient terminal.

This particular embodiment of the invention can be used to ensure that the recipient who will receive the file can actually access the multimedia content. If no identifier relating to the recipient is present in the file, according to the rights of use of the file granted to the sender, the sender can add an identifier of the recipient to the file to give him access to the multimedia content.

This particular embodiment of the invention can thus be used to limit successive transfers of the file to recipients who are unknown or initially undesired by the file creator.

The invention also relates to a method for the reception by a recipient terminal of a file containing controlled-access multimedia content. The reception method comprises:
a step of controlling the access to the multimedia content by the recipient terminal, the control step being executed by the verification of the presence in the received file of an identifier relating to the recipient terminal or to the user of the recipient terminal,
and, if an identifier relating to the recipient terminal or to the user of the recipient terminal is present in the received file, a step of accessing the multimedia content contained in the received file.

In association with this, the invention also relates to a device for receiving a file containing controlled-access multimedia content. The receiving device comprises means for controlling the access to the multimedia content, means for verifying the presence in the received file of an identifier relating to the receiving device or to a user of the receiving device, and means for accessing the multimedia content contained in the received file, the access means being activated if an identifier relating to the receiving device or to a user of the receiving device is present in the received file.

Thus, only the terminals or users for which an identifier has been previously inserted into the file will have access to the multimedia content.

Because of the reception method, a terminal that has received the file or a user of this terminal must have been authorized previously by the file creator or by a user having the right to modify the file, in order to have access to the multimedia content.

The invention also relates to a terminal comprising a transmission device according to any of the embodiments cited above.

The invention also relates to a terminal comprising a receiving device according to any of the embodiments cited above.

The invention also relates to a terminal comprising a transmission device and a receiving device according to any of the embodiments cited above.

The invention also relates to a computer program comprising program code instructions for executing the steps of the transmission method according to any of the embodiments cited above, when the program is run by a processor.

The invention also relates to a computer program comprising program code instructions for executing the steps of the reception method according to any of the embodiments cited above, when the program is run by a processor.

The invention also relates to a digital data signal to be sent to a terminal, comprising controlled-access multimedia content. The signal comprises an identifier relating to the terminal or to a user of the terminal, the identifier being intended to control the access by the terminal to the multimedia content. This signal can be used to protect multimedia content from users or terminals which might attempt to access the multimedia content without being authorized to do so. The multimedia content of the signal cannot be read or opened by a user or terminal whose identifier is not present in the signal.

### LIST OF FIGURES

Other advantages and characteristics of the invention will be more fully evident from the following description of a particular embodiment of the invention, provided as a simple illustrative and non-limiting example, and from the appended drawings, of which:

FIG. 1 shows an environment for the use of a particular embodiment of the invention,

FIG. 2 shows steps of the method for transmitting multimedia content according to a particular embodiment of the invention,

FIG. 3 shows steps of the method for transmitting multimedia content according to another particular embodiment of the invention,

FIG. 4 shows a device for using the method for transmitting multimedia content according to a particular embodiment of the invention,

FIG. 5 shows steps of the method for receiving a file containing multimedia content according to a particular embodiment of the invention,

FIG. 6 shows a device for using the method for receiving a file containing multimedia content according to a particular embodiment of the invention, and

FIG. 7 shows a digital data signal according to a particular embodiment of the invention.

### DESCRIPTION OF A PARTICULAR EMBODIMENT OF THE INVENTION

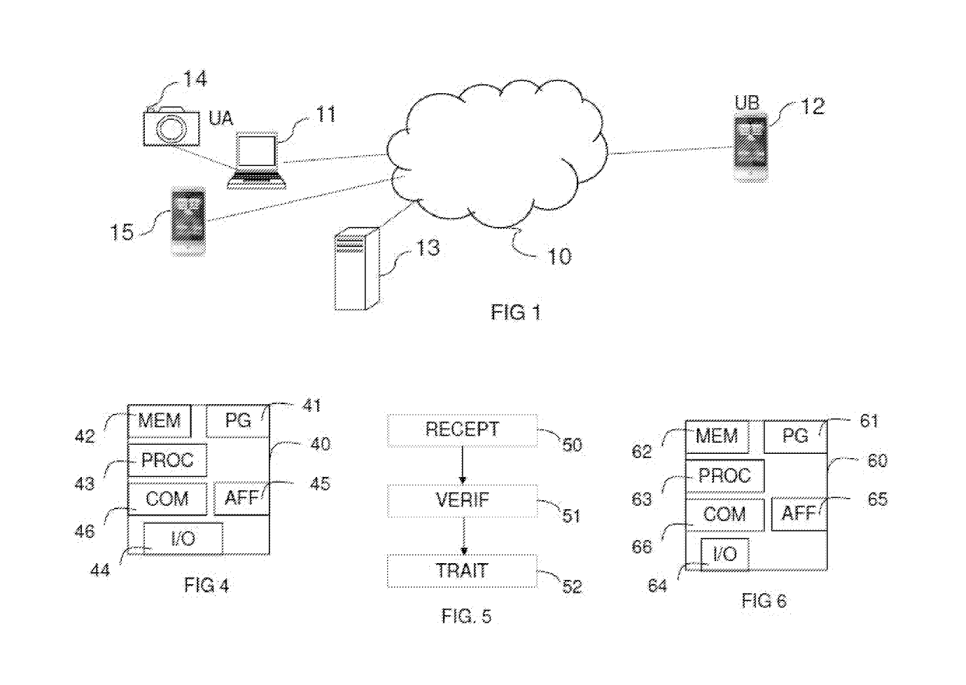

FIG. 1 shows an environment for the use of a particular embodiment of the invention. The invention is intended to protect the multimedia content created by a user UA, using his various multimedia devices 11, 14, 15.

Such a device may, for example, be a digital photographic device, a digital camera, a mobile telephone, a tablet or a personal computer.

The term “multimedia content” here signifies any type of content that can be generated by a device, including an image, a photograph, video, sound, and text.

The user UA may, for example, use his digital photographic device 14 to take a photograph and store it on its personal computer 11, or use his smartphone 15 to create multimedia content.

The user UA may then wish to make the multimedia content that he has created available to a recipient (UB, 12, 13), while retaining control of access to this content by other users and control of the use made of the content by users who access the content.

In the particular embodiment described here, the term “recipient” denotes as a user UB a website or web page stored on the server 13 for example, or a terminal 12 of a user UB.

For example, the user UA may send the multimedia content by any communication mode to a terminal 12 of another user UB via a telecommunications network 10. The user UA may also make the content available by sharing it or publishing it on a web page stored on a server 13 connected to the telecommunications network 10.

The telecommunications network 10 may be, for example, an IP (for the English expression “Internet Protocol”) network, or a mobile telecommunications network of the GSM, EDGE, 3G, 3G+ or other type. The communications network 10 which is shown may be a group of communications networks of different operators interconnected with one another, making it possible to exchange data and establish calls between terminals connected to the communications network 10 via points of access (not shown) to the communications network.

Because of the method for transmitting multimedia content, the user UA can control other users' access to the content. In fact, only a recipient whose identifier has been inserted into the file containing the content will be able to access the content.

The user UA can also control the use made of the content by the users who access it, by inserting rules of use, associated with one or more recipients, into the file containing the multimedia content. The user UA can thus authorize a recipient to read, modify or transfer the content.

Because of the method for receiving a file according to the invention, the user UB can access the multimedia content provided that the user UA has authorized him to do so. The user UB may, for example, receive the file transmitted by the terminal 11 of the user UA on his terminal 12, or may consult the multimedia content on a web page stored on the server 13.

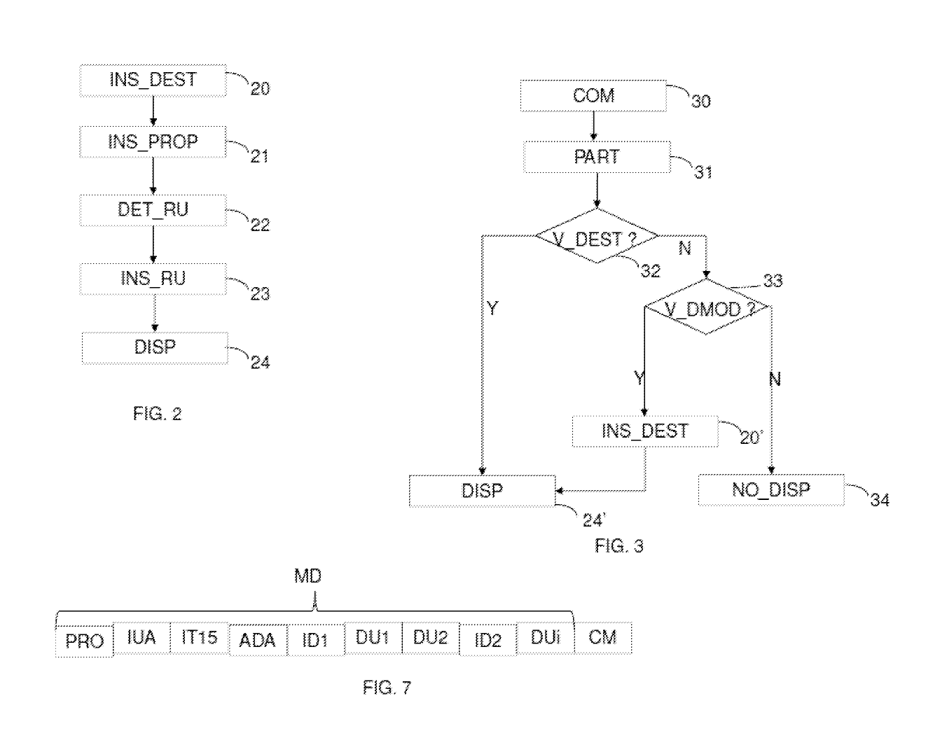

FIG. 2 shows steps of the method for transmitting controlled-access multimedia content according to a particular embodiment of the invention. In the embodiment described here, it is assumed that the multimedia content is created in a known way by the user UA, using one of his multimedia devices 14, 15, 11.

The transmission method is used by the terminal that was used to create the multimedia content. The transmission method can also be used by another terminal to which the multimedia content has been transferred in a known way via a communication means, for example by a file transfer over a local wired or wireless network, or over the internet.

The method comprises a step 20 of inserting an identifier relating to the recipient into a file containing the multimedia content. The term “recipient” is used here to represent a recipient terminal or a user of a recipient terminal for the multimedia content.

The method can insert an identifier relating to a recipient. The method can also insert an identifier relating to a plurality of recipients. The method can also insert a plurality of identifiers relating to a recipient.

The identifier relating to a recipient is inserted into the file containing the multimedia content in the form of metadata. The file contains at least two parts, namely a part comprising the metadata relating to the access rights to the multimedia content, and a part comprising the multimedia content.

The identifier relating to the recipient is inserted into the part of the file comprising the metadata relating to the access rights.

The part of the identifier comprising the metadata relating to the access rights contains a field headed, for example, “access rights holders”, followed by a list of at least one identifier relating to a recipient.

The identifier relating to the recipient may be:
a telephone number to which the recipient may be attached,
an electronic mail address,
an international identification number of a mobile terminal (IMEI, standing for “Internet Mobile Equipment Identity” in English),
an address of a network interface card (the MAC address, where MAC stands for Media Access Control in English) of a terminal,
a serial number of a terminal,
an address (URL, for “Uniform Resource Locator” in English) of a website, a domain name,
an SIP URI address allowing a SIP terminal to be attached,
an IP address for identifying a terminal connected to an IP network.

The method can insert a plurality of different identifiers relating to the same recipient, so that the recipient can access the content from different terminals or from different content access services. For example, the method can insert:
an electronic mail address of the user UB, so that the user UB can access the content from his electronic mail service,
a mobile telephone number, so that the user UB can access the content from the mobile terminal associated with the telephone number,
a website address, so that the user UB can access the content from any terminal by downloading a web page on which the content has been published.

According to a particular embodiment of the invention, the identifier relating to the recipient is an identifier stored in an address book associated with the user UA. The address book may be a local address book stored in the memory of the terminal 15 or 11, or an address book stored on a network server which the terminal can access.

According to a particular embodiment of the invention, the insertion step is performed during the creation of the multimedia content. For example, when the user UA takes a photograph with his smartphone, the method automatically inserts the identifiers of the recipients who have been defined by the user UA as recipients of the multimedia content. The user UA can define the recipients of the content on the fly, at the moment of creation of the content, or in advance, by the creation of lists of recipients stored in the terminal, for example.

According to another particular embodiment of the invention, the user UA can mark the contacts in his address book with an indication identifying the contact as a trusted person. The contacts marked in this way form a group of recipients whose identifiers are automatically inserted into the file containing the multimedia content during its creation.

According to another particular embodiment of the invention, the user UA defines the identifier relating to the recipient by entering the data using an application which displays a dialog window during the creation of the multimedia content or when the user UA wishes to transmit the multimedia content.

According to a particular embodiment of the invention, the method comprises a step 21 of inserting into the file containing the multimedia content at least one identifier relating to the creator of the multimedia content. The term “creator” is used here to represent a terminal that created the multimedia content or a user of a terminal that created the content.

A supplementary field is inserted into the metadata of the file, headed “owner” for example, as illustrated by the reference PRO in FIG. 7. This field is followed by at least one identifier relating to the creator (IUA, IT15 in FIG. 7).

The identifiers inserted into the “owner” field can be used to determine whether a user is authorized to modify the file. By default, the creating user is authorized to modify the multimedia content that he has created or the access rights to the multimedia content. Thus, when a user wishes to modify the access rights to the multimedia content or the multimedia content itself in the file, the method verifies whether the user is the creating user indicated in the “owner” field of the file.

According to a first example, the identifier relating to the creator may be an identifier relating to the terminal of the user UA which has been used to create the multimedia content, for example an international identification number (IMEI) if the terminal is a mobile terminal, or an address of a network interface card (MAC address) or a serial number of a terminal.

The insertion of an identifier of the terminal used to create the multimedia content may take place automatically at the moment of the creation of the multimedia content by the terminal. Thus the multimedia content created by a user is automatically marked by the terminal that was used to create this multimedia content. The creating user does not have to mark his multimedia content himself manually or on each creation of multimedia content.

In this example, the identifiers inserted into the “owner” field can be used to determine the terminal from which the creating user can modify the file. The multimedia content may have been created by a first terminal of the creating user and may be modified by another terminal. On the other hand, the creating user may wish that only the terminal used for creating the multimedia content be authorized to modify the multimedia content.

According to a second example, the identifier may also be an identifier relating to the user UA, for example a telephone number to which the user may be attached or electronic mail address of the user UA, or alternatively a SIP URI address. In this example, the creating user can use any terminal to modify the multimedia content or the access rights to the multimedia content. In order to modify the multimedia content or the access rights to the multimedia content, the creating user must be identified by the application used for opening the file containing the multimedia content, with the identifier inserted into the “owner” field.

According to another example, the “owner” field may also contain a plurality of identifiers relating to the creator, so that the creating user benefits from a plurality of means of modifying the file containing the multimedia content.

According to a particular embodiment of the invention, the transmission method comprises a step 22 of determining at least one rule for the use of the multimedia content associated with the recipient terminal or with the user of the recipient terminal.

A rule for the use of the multimedia content is a process which the recipient terminal or the recipient user can execute on the multimedia content. The processes executed on the multimedia content may, for example, be:
reading the multimedia content. This process may be accompanied by a parameter showing the number of times that the recipient can execute this process: 1 time, N times, or an unlimited number of times.
recording the content in a local memory of the terminal, or on a recording medium connected to the terminal such as a hard disk, a USB drive, or a memory card.
sharing the content on a social network or a website, or by telephone. This process may be accompanied by the identifiers of the authorized users or terminals concerned with the sharing. In the case of the example of sharing to a social network, the recipient identifier inserted into the metadata is the identifier of the recipient user on the social network, the associated rule of use is “share”, and the parameter associated with this rule is, for example, “friends”. These metadata indicate that the multimedia content can be shared on the social network for the users of the social network belonging to the group of friends of the recipient defined in the social network.
deleting the content on the recipient terminal, this process possibly being accompanied by a parameter determining the moment at which the content is deleted: after a single reading of the content, after N readings, or after a specified date.
transmitting the content to other recipients. This process may be accompanied by an identifier of the applications authorized to carry out this transmission, for example an electronic mail program, a telephony application, or communication protocols.
modifying the file: this process may be accompanied by the type of modification authorized: for example, adding recipients to the metadata of the file, or modifying the multimedia content.

According to a particular embodiment of the invention, the determination of a rule of use is carried out manually by the user creating the multimedia content. The creating user may determine the same possible rules of use for all the recipients. The creating user can also refine the determination of the rules of use for each recipient or for each group of recipients.

According to a particular embodiment of the invention, the determination of a rule of use is carried out automatically at the time of insertion of an identifier relating to a recipient on the basis of a predetermined criterion. For example, the determination of a rule of use is performed on the basis of a group to which the recipient belongs. Default rules of use are defined in advance for groups of recipients. For example, the recipients marked as trusted persons may benefit from rules of use such as unlimited reading of the content, transmission of the content to other recipients, and recording of the content.

According to another example, the determination of a rule of use is carried out on the basis of a history of calls exchanged between the sending terminal and the recipient terminal. A recipient with whom the sender is communicating for the first time will have a right to a single reading of the content only, with deletion of the content after the single reading. A recipient with whom the sender communicates frequently will have the right to reading for N times.

After the step 22 of determining at least one rule of use, the method comprises a step 23 of inserting a data element representative of the at least one determined rule of use into the file.

According to a variant, the data element representative of the at least one determined rule of use is inserted into the metadata of the file after the identifier relating to the recipient with whom it is associated, as illustrated by the references DU1, DU2, DUi in FIG. 7.

According to another variant, the data element representative of the at least one determined rule of use is inserted into the metadata of the file in a field headed, for example, “rights of use”. In this variant, the same rules of use are associated with all the recipients for whom an identifier has been inserted into the metadata of the file.

The method then comprises a step 24 of sending the file to at least the recipient terminal. The sending of the file may consist in a transmission of the file to the recipient terminal in any known form of call, for example an electronic message, an SMS (for “Short Message Service” in English), a file transfer according to a known protocol FTP, (for “File Transfer Protocol” in English), http (for “HyperText Transfer Protocol” in English), RCS (for “Rich Communication Service” in English), or a local call via the Bluetooth® or WiFi protocol.

According to a particular embodiment of the invention, the recipient terminal is a storage server, for example a server hosting a website enabling content to be shared with other users, such as a photograph sharing site, a video sharing site, or a social network site.

FIG. 3 shows steps of the method for transmitting controlled-access multimedia content according to another particular embodiment of the invention. In the embodiment described here, the user UA has multimedia content on his terminal 15 shown in FIG. 1.

In a step 30, a call is established in a known way between the terminal 15 of the user UA and the terminal 12 of the user UB, with reference to FIG. 1. The call is established, for example, by a GSM (for “Global System for Mobile communication” in English) communication circuit, or a VoIP SIP (for “Voice Over IP” in English) communication.

During the call, the user UA wishes to share the multimedia content stored on his terminal 15 with the user UB. For this purpose, the user UA uses the “photo sharing RCS” function of the communication application executed on his terminal 15. In a step 31, the terminal 15 displays to the user UA an interface allowing the user UA to select the multimedia content that he wishes to transmit to the user UB. On the interface, the user UA also selects the “share” communication option.

During step 31, the communication application executed on the terminal 15 then verifies whether the user UA is authorized to share the multimedia content. The communication application verifies whether an identifier of the user UA or of the terminal 15 is present in the “owner” field of the metadata of the file. The communication application may, for example, verify the presence of the telephone number of the user UA or the IMEI number of the terminal 15.

If other identifiers relating to the terminal 15 or to the user UA are stored on the terminal 15 in association with the telephone number of the user UA or on the SIM card of the terminal 15, the communication application verifies whether one of these identifiers is present in the “owner” field of the metadata of the file.

If at least one identifier relating to the user UA or to the terminal 15 is present in the “owner” field of the metadata, the user UA is authorized to share the multimedia content.

If no identifier relating to the user UA or to the terminal 15 is present in the “owner” field of the metadata, the communication application verifies whether at least one identifier of the user UA or of the terminal 15 is present in the “access rights holders” field of the metadata of the file. If an identifier of the user UA or of the terminal 15 is present, the communication application verifies whether a rule of use authorizing the sharing of the multimedia content via the “photo sharing RCS” is associated with the identifier that is present. If this is the case, the user UA is authorized to share the multimedia content. Otherwise, the user UA is not authorized to share the multimedia content. If the user UA is authorized to share the multimedia content, the method continues with a step 32 in which the communication application executed on the terminal 15 verifies, in the file containing the multimedia content, the presence of an identifier relating to the terminal 12 or to the user UB of the terminal 12. Since a call is in progress between the terminal 15 and the terminal 12, the telephone number of the user UB is known by the terminal 15.

The communication application verifies whether the telephone number of the user UB is present in the “access rights holder” field of the metadata of the file.

If other identifiers relating to the terminal 12 or to the user UB are stored on the terminal 15 in association with the telephone number of the user UB, the communication application verifies whether one of these identifiers is present in the “access rights holder” field of the metadata of the file.

If an identifier of the user UB or of the terminal 12 is present in the metadata, the communication application transfers the file containing the multimedia content to the terminal 12 of the user UB, according to the RCS standard, in a step 24′.

If no identifier of the user UB or of the terminal 12 is present in the metadata, the communication application executed on the terminal 15 displays to the user UA a window indicating that the user UB is not authorized to access the multimedia content.

In a step 33, the communication application verifies whether the user UA is authorized to modify the metadata of the file containing the multimedia content. If, in step 31, the communication application has determined that the user UA is the user who owns the multimedia content, the user UA is then authorized to modify the metadata.

If the user UA is not the user who owns the multimedia content, the communication application verifies in the metadata of the file whether a rule of use authorizing the modification of the metadata is associated with an identifier of the user UA or of the terminal 15.

In step 33, the communication application then offers the user UA the possibility of cancelling the sharing of the multimedia content with the user UB, or adding the user UB, as an access rights holder, to the metadata of the file if the user UA is authorized to do so.

If the user UA chooses to cancel the share, or if he is not authorized to modify the metadata, then, in a step 34, the communication application terminates the content sharing process via the “photo sharing RCS” function, and the file is not transmitted to the terminal 12.

If the user UA chooses to add the user UB as an access rights holder in the metadata of the file, the communication application inserts, in a step 20′, at least one identifier relating to the terminal 12 or to the user UB, in the “access rights holder” field of the metadata of the file.

By default, the rule of use associated with the identifier inserted in step 20′ is the reading of the content.

In a variant, the user UA can define other rules of use associated with the identifier inserted in step 20′.

The communication application then transfers the file containing the multimedia content to the terminal 12 of the user UB, according to the RCS standard, in a step 24′.

FIG. 4 shows a device 40 for using the method for transmitting controlled-access multimedia content according to a particular embodiment of the invention.

The device comprises a storage space 42, for example a memory (MEM), a processing unit 43, equipped with a microprocessor (PROC) for example, and controlled by the computer program (PG) 41, using the method for transmitting controlled-access multimedia content to at least one recipient terminal such as that described in the invention in relation to FIG. 2 or FIG. 3.

On initialization, the code instructions of the computer program 41 are, for example, loaded into the memory before being executed by the processor of the processing unit 43. The microprocessor of the processing unit 43 executes the steps of the method for transmitting controlled-access multimedia content to at least one recipient terminal, and notably the steps of inserting into a file containing the multimedia content at least one identifier relating to the recipient terminal or to the user of the recipient terminal, the identifier being intended to control access to the multimedia content by the recipient terminal, and sending the file to at least the recipient terminal, according to the instructions of the computer program 41.

The storage space 42 can also be used, for example, to store the controlled-access multimedia content.

According to a particular embodiment of the invention, the storage space 42 can also be used to store an address book of contacts of a user of the device.

The device also comprises a user interface 44 (I/O) enabling the user to interact with the device 40. This user interface may, for example, be a keyboard, a mouse, or a touch screen.

The device also comprises a display means 45 (AFF) which can be used, for example, to display multimedia content to the user, with windows for interaction with a software application executed by the device.

The device also comprises a network access unit 46 (COM) which, for example, enables the device 40 to access the internet or to establish calls via different communications networks, for example a mobile telephone network, a computer network, or a satellite network.

The device 40 is contained in a terminal such as, for example, a fixed or mobile personal computer, a mobile telephone, a tablet, a photographic apparatus, or a communicating digital camera.

FIG. 5 shows steps of the method for receiving a file containing controlled-access multimedia content according to a particular embodiment of the invention. The method is used by a recipient terminal, for example the terminal 12 of the user UB as shown in FIG. 1.

The terminal 12 receives, in a step 50, a file containing controlled-access multimedia content. The received file has, for example, been transmitted by the terminal 11 or 15 of the user UA according to a particular embodiment of the method for transmitting controlled-access multimedia content as described in relation to FIG. 2 or 3. In a variant, the terminal 12 may have received the file containing the multimedia content by a data transfer on a local network, or from an external storage space connected to the terminal 12, for example a USB flash drive.

For example, if the file has been transmitted in the form of an electronic message of the email or MMS (for Multimedia Message Service in English) type, or in the form of a voice message, then in step 50, and in a known manner, the terminal 12 receives from a mail server the file stored on the server, using a mail application executed by the terminal.

If the file is transmitted according to the RCS standard, the telephony application executed on the terminal 12 downloads the sent file in a known manner from the sending terminal.

The file is recorded in memory at the terminal 12.

The terminal 12 then executes a step 51 of controlling the access to the multimedia content. The control step is executed by verifying the presence in the received file of an identifier relating to the recipient terminal 12 or to the user UB of the recipient terminal.

An identifier relating to the terminal 12 may consist in the IMEI number of the terminal. An identifier relating to the user UB may consist in the telephone number of the user UB or an electronic mail address. At least one identifier relating to the recipient terminal or to the recipient user is stored in a memory of the terminal 12 or on the SIM card of the terminal 12.

The terminal 12 scans the received file and verifies whether at least one identifier relating to the recipient is present in the “access rights holder” field of the file.

If an identifier relating to the recipient is present in the received file, the terminal 12 executes a step 52 of accessing the multimedia content contained in the received file.

In the case of a file in the form of a message, this step consists, for example, in the opening of the message by the mail application, or in the reading of the message in the case of a voice message, for example.

If the multimedia content is an image or a video, the access step consists, for example, in displaying the content on the screen of the recipient terminal.

If no identifier relating to the recipient is present in the received file, the terminal 12 deletes the recorded file.

According to another particular embodiment of the invention, the terminal 12 initially receives only the metadata of the file containing the multimedia content. The multimedia content is then downloaded and stored in memory on the terminal, if an identifier relating to the recipient is present in the received file. In this particular embodiment of the invention, the access step consists, notably, in the reception of the multimedia content on the terminal 12.

According to a particular embodiment of the invention, the terminal 12 also reads from the file a data element representative of at least one rule of use associated with the identifier relating to the recipient, and stores this data element in memory, in association with the received file or an indicator pointing to the received file.

Then, according to the rule of use of the file associated with the recipient, the user UB will be able to execute different actions on the multimedia content from the terminal 12.

For example, a rule of use in the file associated with the recipient's identifier may be access or reading limited to once only or to N times. In this example, the terminal 12 starts a reading counter at zero.

On each access to the multimedia content, the terminal 12 increments the counter. When the counter reaches the maximum authorized number of accesses to the multimedia content, access to the multimedia content ceases to be authorized.

According to a variant, when the maximum authorized number of accesses to the multimedia content is reached, the terminal 12 deletes the file containing the multimedia content from the storage memory.

After reading the rules of use associated with the identifier relating to the recipient, the terminal 12 displays to the user, according to the rights granted, the possible actions on the multimedia content. For example, this display can be provided in the form of a menu containing the possible actions. Unauthorized actions are not displayed.

For example, if the user UB wishes to record the multimedia content in a memory location other than the location where the file is stored, the “record” menu appears only if recording is authorized.

According to another particular embodiment of the invention, the file containing the controlled-access multimedia content may have been sent to a server which hosts, for example, a site for sharing the multimedia contents.

In this embodiment, in step 50, the web browser of the terminal 12 used to display the web page of the content sharing site downloads, in a known way, the web page containing a link to the multimedia content. The web browser also downloads, in a known way, the file containing the multimedia content. The browser then verifies in step 51 whether the domain name or URL corresponding to the website is present in the “rights of use holder” field of the metadata of the multimedia content file. If this is the case, the web browser displays the multimedia content on the terminal 12. In a similar manner to that of the preceding embodiment, possible actions such as recording or transferring the multimedia content are displayed on the basis of the rules of use specified in the metadata associated with the identifier relating to the recipient in the file and read by the web browser.

In a variant of this particular embodiment of the invention, access to the multimedia content is provided by verifying the presence of an identifier relating to the content sharing site, and then verifying the presence of an identifier relating to the user displaying the web page of the content sharing site. In this case, the identifier relating to the user consists, for example, in the identifier enabling him to identify himself on the content sharing site.

FIG. 6 shows a device 60 for using the method for receiving a file containing controlled-access multimedia content according to a particular embodiment of the invention.

The device comprises a storage space 62, for example a memory (MEM), a processing unit 63, equipped with a microprocessor (PROC) for example, and controlled by the computer program (PG) 61, executing the method for receiving controlled-access multimedia content as described in the invention in relation to FIG. 5.

On initialization, the code instructions of the computer program 61 are, for example, loaded into the memory before being executed by the processor of the processing unit 63. The microprocessor of the processing unit 63 executes the steps of the method for receiving controlled-access multimedia content in a recipient terminal, and notably the steps of controlling access to the multimedia content, verifying presence in the received file of an identifier relating to the recipient terminal or to the user of the recipient terminal, and, if an identifier relating to the recipient terminal or to the user of the recipient terminal is present in the received file, accessing the multimedia content contained in the received file, according to the instructions of the computer program 61.

The storage space 62 can also be used to store the controlled-access multimedia content.

The device also comprises a user interface 64 (I/O) enabling the user to interact with the device 60. This user interface may, for example, be a keyboard, a mouse, or a touch screen.

The device also comprises a display means 65 (AFF) which can be used, for example, to display multimedia content to the user, with windows for interaction with a software application executed by the device.

The device also comprises a network access unit 66 (COM) which, for example, enables the device 60 to access the internet or to establish calls via different communications networks, for example a mobile telephone network, a computer network, or a satellite network.

The device 60 is contained in a terminal such as, for example, a fixed or mobile personal computer, a mobile telephone, a tablet, a photographic apparatus, or a communicating digital camera.

FIG. 7 shows a digital data signal according to a particular embodiment. The signal is intended to be transmitted to a recipient terminal. The signal has, for example, been generated by the transmission of a file comprising controlled-access multimedia content according to a particular embodiment of the method for transmitting the file as described in relation to FIG. 2 or 3.

The reception of the signal by the recipient terminal can be executed according to a particular embodiment of the method for receiving the file as described in relation to FIG. 5.

The signal of FIG. 7 represents a file comprising controlled-access multimedia content CM. The signal also comprises metadata MD. The metadata MD comprise a field ADA signaling a list of holders of access rights to the multimedia content; the field ADA is followed by a list of at least one identifier ID1, ID2 relating to a terminal which is the recipient of the multimedia content or to the user of the terminal which is the recipient of the multimedia content. The identifier ID1, ID2 relating to a recipient terminal or to the user of the recipient terminal is intended to control access to the multimedia content by the terminal receiving the signal.

According to a particular embodiment of the invention, the identifiers relating to the recipient terminal or to the user of the recipient terminal are followed by a list of at least one rule of use DU1, DU2, DUi for indicating the authorized actions that can be performed on the multimedia content by the terminal receiving the signal. In the example of FIG. 7, the identifier ID1 is followed by the rules of use DU1 and DU2, and the identifier ID2 is followed by the rule of use DUi.

According to another particular embodiment of the invention, the metadata MD of the file comprise a field PRO signaling the list of the identifiers of the user creating the multimedia content or of the terminal of the creating user. The field PRO is followed by a list of at least one identifier relating to the terminal that created the multimedia content or to the user of the terminal that created the multimedia content. In the example of FIG. 7, the field PRO is followed by an identifier IUA relating to the user UA of FIG. 1 and by an identifier IT15 relating to the terminal 15 of the user UA of FIG. 1.

1. A method of transmitting a controlled-access multimedia content to at least one recipient terminal, characterized in that, it comprises:
a step of inserting into a file containing the multimedia content at least one identifier relating to the recipient terminal or to the user of the recipient terminal, the identifier being intended to control, on the recipient terminal, the access to the multimedia content by the recipient terminal, and
a step of sending the file to at least the recipient terminal.

2. The transmission method as claimed in claim 1, characterized in that the identifier relating to the recipient terminal or to the user of the recipient terminal is an identifier contained in an address book stored in the terminal sending the multimedia content, or in remote equipment.

3. The transmission method as claimed in claim 1, characterized in that it further comprises a step of inserting into the file containing the multimedia content at least one identifier relating to the terminal that created the multimedia content or to the user of the terminal that created the multimedia content.

4. The transmission method as claimed in claim 1, characterized in that the identifier relating to the recipient terminal or to the user of the recipient terminal and/or the identifier relating to the terminal that created the multimedia content or to the user of the terminal that created the multimedia content belongs to the group comprising:
a telephone number,
an address of a network interface card of a terminal,
an electronic mail address,
an international identification number of a mobile terminal,
a serial number of a terminal,
an address of a website,
a domain name.

5. The transmission method as claimed in claim 1, characterized in that it further comprises:
a step of determining at least one rule for using the multimedia content associated with the recipient terminal or with the user of the recipient terminal, and
a step of inserting a data element representative of the at least one determined rule of use into the file.

6. The transmission method as claimed in claim 5, characterized in that the determination of the at least one rule of use is carried out on the basis of a history of calls exchanged between the terminal sending the multimedia content and the recipient terminal.

7. The transmission method as claimed in claim 1, characterized in that it comprises, before the step of inserting into the file containing the multimedia content an identifier relating to the recipient terminal or to the user of the recipient terminal:
a step of verifying the presence of an identifier relating to the terminal sending the multimedia content or to the user of the terminal sending the multimedia content,
and a step of verifying the rules of use of the multimedia content associated with the identifier relating to the terminal sending the multimedia content or to the user of the terminal sending the multimedia content.

8. The transmission method as claimed in claim 7, characterized in that it comprises, before the step of sending the file, a step of verifying the presence in the file of an identifier relating to the recipient terminal or to the user of the recipient terminal.

9. A method for the reception by a recipient terminal of a file containing controlled-access multimedia content, characterized in that it comprises:
a step of controlling the access to the multimedia content by the recipient terminal, the control step being executed by the verification of the presence in the received file of an identifier relating to the recipient terminal or to the user of the recipient terminal,
and, if an identifier relating to the recipient terminal or to the user of the recipient terminal is present in the received file, a step of accessing the multimedia content contained in the received file.

10. A device for transmitting controlled-access multimedia content to at least one recipient terminal, characterized in that it comprises:
means for inserting into a file containing the multimedia content at least one identifier relating to the recipient terminal or to the user of the recipient terminal, the identifier being intended to control the access to the multimedia content by the recipient terminal,
means for sending the file to at least the recipient terminal.

11. A device for receiving a file containing controlled-access multimedia content, characterized in that it comprises:
means for controlling the access to the multimedia content,
means for verifying the presence in the received file of an identifier relating to the receiving device or to a user of the receiving device,
means for accessing the multimedia content contained in the received file, the access means being activated if an identifier relating to the receiving device or to a user of the receiving device is present in the received file.

12. A terminal comprising a device for transmitting controlled-access multimedia content to at least one recipient terminal, characterized in that it comprises:
means for inserting into a file containing the multimedia content at least one identifier relating to the recipient terminal or to the user of the recipient terminal, the identifier being intended to control the access to the multimedia content by the recipient terminal,
means for sending the file to at least the recipient terminal.

13. A terminal comprising a device for receiving a file containing controlled-access multimedia content, characterized in that it comprises:
means for controlling the access to the multimedia content,
means for verifying the presence in the received file of an identifier relating to the receiving device or to a user of the receiving device,
means for accessing the multimedia content contained in the received file, the access means being activated if an identifier relating to the receiving device or to a user of the receiving device is present in the received file.

14. A computer program comprising program code instructions for executing steps of a transmission method for transmitting a controlled-access multimedia content to at least one recipient terminal, when the program is run by a processor, the transmission method comprising:
a step of inserting into a file containing the multimedia content at least one identifier relating to the recipient terminal or to the user of the recipient terminal, the identifier being intended to control, on the recipient terminal, the access to the multimedia content by the recipient terminal, and
a step of sending the file to at least the recipient terminal.

15. A digital data signal to be sent to a recipient terminal, comprising controlled-access multimedia content, characterized in that it comprises an identifier relating to the recipient terminal or to the user of the recipient terminal, the identifier being intended to control, at the recipient terminal, the access to the multimedia content by the recipient terminal.

16. The transmission method as claimed in claim 1, the insertion step is performed during a current call between a terminal sending the multimedia content and the recipient terminal.

17. A computer program comprising program code instructions for executing steps of a reception method for the reception by a recipient terminal of a file containing controlled-access multimedia content, when the program is run by a processor, the reception method comprising
a step of controlling the access to the multimedia content by the recipient terminal, the control step being executed by the verification of the presence in the received file of an identifier relating to the recipient terminal or to the user of the recipient terminal,
and, if an identifier relating to the recipient terminal or to the user of the recipient terminal is present in the received file, a step of accessing the multimedia content contained in the received file
